(19) United States
(12) Patent Application Publication
(10) Pub. No.: US 2013/0275451 A1
(43) Pub. Date: Oct. 17, 2013

(54) Systems And Methods For Contract Assurance

(71) Applicants: Christopher Scott Lewis, Greensboro, NC (US); James B. Arnold, Greensboro, NC (US); Jim Riley, Oak Ridge, NC (US)

(72) Inventors: Christopher Scott Lewis, Greensboro, NC (US); James B. Arnold, Greensboro, NC (US); Jim Riley, Oak Ridge, NC (US)

(21) Appl. No.: 13/665,024

(22) Filed: Oct. 31, 2012

Related U.S. Application Data
(60) Provisional application No. 61/553,780, filed on Oct. 31, 2011.

(51) Int. Cl. G06F 17/30

(52) U.S. Cl. CPC G06F 17/30011
USPC 707/758

(57) ABSTRACT

Systems and methods for contract assurance are disclosed. For example, one disclosed method includes the steps of receiving a document, the document including a keyword; determining a location of the keyword within the document; searching for a value associated with the keyword; responsive to identifying the value associated with the keyword, storing a location of the value; generating a template based on the location of the keyword and the location of the value; extracting the value from the document using the template; and responsive to extracting the value, storing and associating a label and the extracted value in a second document, the label associated with the keyword. Another disclosed embodiment includes program code for causing a processor to execute such a method.

### CROSS-REFERENCES TO RELATED APPLICATION

This application claims priority to U.S. Provisional Patent Application No. 61/553,780, filed Oct. 31, 2011, entitled “Systems and Methods for Contract Assurance,” the entirety of which is hereby incorporated by reference.

### FIELD

The present disclosure relates to systems and methods generally relates to systems and methods for contract assurance and more specifically relates to analyzing contract documents to ensure adherence to terms.

### BACKGROUND

In conventional contractual arrangements for purchase of goods or services, a supplier will typically agree to supply a particular good or service at a certain price. In some cases, the supplier will also provide discounts or product bundles under the terms of the agreements. However, when a buyer receives an invoice for the purchase of certain items under the agreement, it may or may not accurately reflect the cost of the goods or services purchased. For example, in some cases a supplier may not correctly apply discount or bundle pricing to purchased goods or services. Thus, while a buyer may have negotiated a favorable price for a particular good or service, it may lose the benefit of its bargain due to incorrect invoicing by the seller.

In the past, to attempt to provide a methodical way to analyze deal information, crude generic templates have been created for use in searching for relevant deal data within electronic documents; however, such efforts have been largely unsuccessful or have had poor results because data in such negotiation documents is rarely formatted in a uniform way. Thus, a generic template expecting data in a particular location of an electronic document frequently identifies no data or identifies data that, while potentially relevant, is unrelated to the data field in the template and thus may provide misleading or incorrect information. And while systems for extracting data from rigidly defined documents, such as forms, are available, such systems rely on adherence to the form and are unsuitable for unstructured or inconsistently formatted negotiation documents.

### SUMMARY

Embodiments according to the present disclosure provide systems and methods for contract assurance. For example, one embodiment comprises a method comprising the steps of receiving a document, the document comprising the keyword; determining a location of the keyword within the document; using the location of the keyword, searching for a value associated with the keyword; responsive to identifying the value associated with the keyword, storing a location of the value; generating a template based on the location of the keyword and the location of the value; extracting the value from the document using the template; and responsive to extracting the value, storing and associating a label and the extracted value in a second document, the label associated with the keyword. In another embodiment, a computer-readable medium comprises program code for causing a processor to execute such a method.

These illustrative embodiments are mentioned not to limit or define the disclosure, but rather to provide examples to aid understanding thereof. Illustrative embodiments are discussed in the Detailed Description, which provides further description of the disclosure. Advantages offered by various embodiments of this disclosure may be further understood by examining this specification.

### BRIEF DESCRIPTION OF THE DRAWINGS

The accompanying drawings, which are incorporated into and constitute a part of this specification, illustrate one or more examples of embodiments and, together with the description of example embodiments, serve to explain the principles and implementations of the embodiments.

FIGS. 1-2 show systems for contract assurance according to embodiments;

FIG. 3 shows a method for contract assurance according to one embodiment;

FIGS. 4-6 show example input documents according to embodiments;

FIG. 7 shows an example template according to one embodiment; and

FIG. 8 shows an example output document according to one embodiment.

### DETAILED DESCRIPTION

Example embodiments are described herein in the context of systems and methods for contract assurance. Those of ordinary skill in the art will realize that the following description is illustrative only and is not intended to be in any way limiting. Other embodiments will readily suggest themselves to such skilled persons having the benefit of this disclosure. Reference will now be made in detail to implementations of example embodiments as illustrated in the accompanying drawings. The same reference indicators will be used throughout the drawings and the following description to refer to the same or like items.

### Illustrative Method for Contract Assurance

In one illustrative embodiment of a method for contract assurance, a purchaser and a vendor engage in negotiations regarding a contract for the purchase of various items and services from the vendor. During the negotiations, pricing and related information is exchanged electronically, such as within emails, spreadsheets, PDFs, and other documents. Once the negotiations have concluded, the vendor begins providing products or services to the purchaser, and later invoices the purchaser for those products and services.

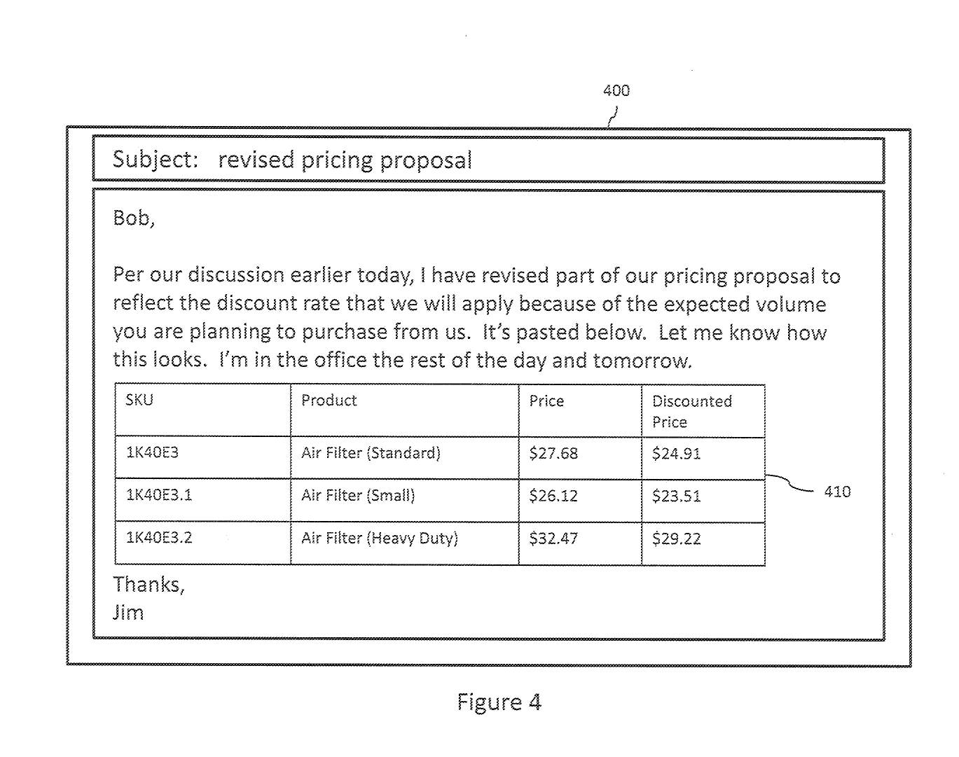

After the negotiations have concluded, the purchaser executes a software application and provides electronic documents residing within the purchaser's email, including various emails exchanged between the purchaser and the vendor, other document systems, or file systems. For example, FIG. 4 shows an email 400 with pricing information 410 embedded within the text of the email that shows a new pricing proposal for several items. In addition, the purchaser maintains and provides a list of keyword terms to the application to assist in identifying relevant information within the various documents, such as “item,” “price,” “SKU,” “UPC,” and “discount.” The software application searches the identified documents to identify potentially relevant documents based on the list of keywords. Once a group of potentially relevant documents is identified, such as the email 400 in FIG. 4, each document is individually, and automatically, analyzed to dynamically generate a virtual template representative of the document. The virtual template includes locations of relevant terms based on keywords located within the document (e.g. Discounted Price) and a relative location within the document of an associated value or values (e.g. $24.91). For example, in FIG. 4, a number of cells may be identified within the table 410 in the email 400 having relevant terms, including SKU, Product, Price, and Discounted Price. For each of these cells, one or more additional cells is then identified that corresponds to the cells having relevant terms, such as the three cells below the identified “SKU” cell. Thus, the template may include data describing the location of the “SKU” keyword, e.g. (x,y) location (1,1) in the table, and the locations of associated values, e.g. locations (2,1), (3,1), and (4,1). Once the template is constructed, the software application then applies the template to the document to extract data from the document and store the extracted data in a standardized format in a database. For example, the template information is applied to the document to create a row in a database table. The row in the table has standardized names, e.g. item number, item name, item price, and discount item price. The data extracted from the email is then stored in the database table. After the data is extracted from the email, the template constructed for the email is discarded and the process is repeated on the next document, including dynamically generating a new template.

After each relevant document has been analyzed, the database has data indicating the agreed-upon terms for the vendor relationship. The purchaser may then execute an analysis of invoices received from the vendor to ensure the invoice properly reflects the pricing agreed upon during negotiations.

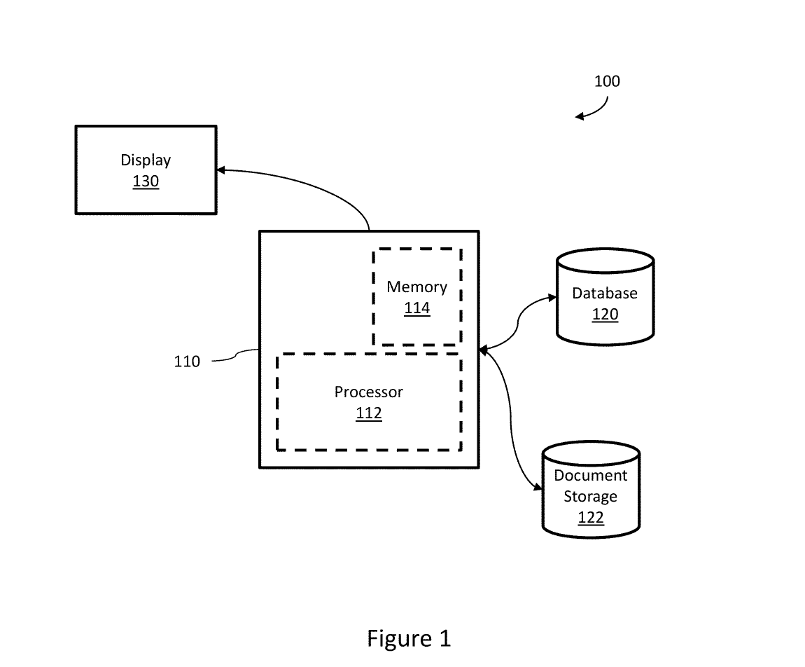

Systems according to this disclosure may be embodied by a variety of different computer systems. For example, referring now to FIG. 1, FIG. 1 shows a system 100 for contract assurance according to one embodiment. In the embodiment shown in FIG. 1, the system 100 comprises a computer 110 having a processor 112 and memory 114 in communication with the processor 112. The computer 110 is in communication with a database 120, document storage 122, and a display 130. The database 120 is configured to store data extracted from one or more documents. Suitable processors and memory are discussed in greater detail below. In the embodiment shown in FIG. 1, the database comprises a relational database; however, other suitable databases may be used, such as object-oriented databases, transactional databases, or hybrid databases (e.g. object-relational databases).

While FIG. 1 shows a single computer 110, other embodiments may comprise a plurality of computers or servers, or a plurality of processors. In some such embodiments, a plurality of servers may be in communication over a network, such as a wired (e.g. Ethernet, fiber optic, Token ring, USB, Firewire, etc.) or wireless network (e.g. 802.11b, g, n, WiFi, etc.). In some embodiments, the database may be managed by a further computer or server or may be distributed amongst a number of database servers. The processor 112 may be in communication with the database 120 via a network. In some embodiments, the computer 110 may host the database 120 itself. Still further suitable arrangements would be apparent to one of skill in the art.

In the embodiment shown in FIG. 1, document storage comprises a computer-readable medium having one or more documents stored therein. For example, in the embodiment shown in FIG. 1, document storage 122 comprises an email repository, such as a Microsoft Exchange server. In some embodiments, the document storage may comprise a user's hard disk, a network storage location, a storage area network, or other computer-readable medium (or media) having one or more documents stored therein.

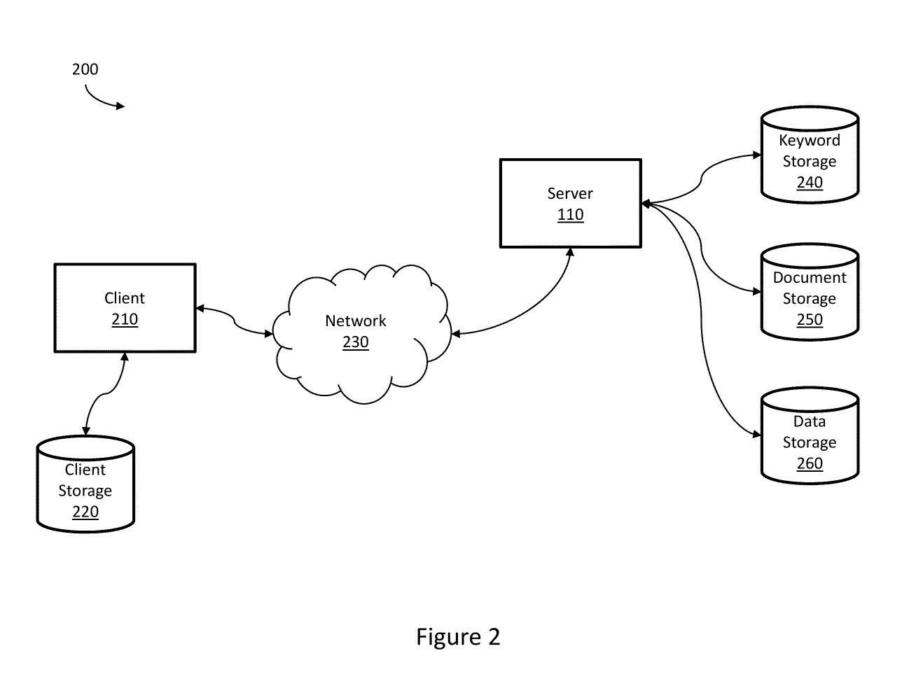

Referring now to FIG. 2, FIG. 2 shows a system 200 according to one embodiment. The system shown in FIG. 2 comprises a client computer (or computers) 210 in communication with a server (or servers) 110 using a network 230. The client computer is in communication with one or more storage devices 220 that comprise documents maintained by the client that may include contract data for analysis and data extraction for contract assurance according to various embodiments. The server 110 comprises one or more computers 110. The server 110 is in communication with keyword storage 240, document storage 250, and data storage 260. In addition, the server 110 is in communication with the client computer 210.

As described with respect to FIG. 1, the server 110 comprises one or more processors 112 (or may comprise a virtual server executed by one or more processors) in communication with a computer readable medium 114. The processor 112 is configured to execute program code stored in the computer readable medium 114 and to communicate with keyword storage 240, document storage 250, and data storage 260, as well as client computer 210. The server 110 also comprises a network interface (not shown) in communication with the processor for enabling communication over the network 230 or with one or more of keyword storage 240, document storage 250, and data storage 260.

In the embodiment shown in FIG. 2, keyword storage 240 comprises a database, or a part of a database, configured to store one or more keywords. In this embodiment, keyword storage 240 comprises a table in a relational database that stores a plurality of keywords, however, in some embodiments, keyword storage 240 may comprise a flat file stored in a computer readable medium. In further embodiments, keyword storage 240 may comprise one or more suitable storage mechanism for storing keywords and allowing subsequent retrieval of the keywords. In some embodiments, keyword storage 240 may be comprised within server 110, such as on a hard drive or other storage device within server 110. In some embodiments, keyword storage 240 may be stored on a different computer or computers connected to server 110 over a network or other communications mechanism.

Document storage 250 in this embodiment comprises a database configured to store one or more documents for analysis according to embodiments. For example, document storage 250 may comprise one or more file system locations on a hard disk or other non-volatile computer-readable medium that may be accessed by the server 110. In some embodiments, document storage 250 may comprises a plurality of storage locations, such as an email server, a directory in a file system, and a document storage system. Still other suitable mechanisms or systems for document storage 250 may be used according to various embodiments. In some embodiments, document storage 250 may be comprised within server 110, such as on a hard drive or other storage device within server 110. In some embodiments, document storage 250 may be stored on a different computer or computers connected to server 110 over a network or other communications mechanism.

In the embodiment shown in FIG. 2, data storage 260 comprises a relational database configured to store data extracted from documents in document storage 250. In some embodiments, data storage 260 comprises one or more files stored in a directory (or directories) of file system, such as one or more spreadsheet files, XML files, or other files. Still other suitable mechanisms or systems for data storage 260 may be used according to various embodiments. In some embodiments, document storage 250 may be comprised within server 110, such as on a hard drive or other storage device within server 110. In some embodiments, data storage 260 may be stored on a different computer or computers connected to server 110 over a network or other communications mechanism.

The client computer 210 according to various embodiments may comprise any suitable computer system or systems that have access to documents for analysis according to systems and methods of this disclosure. For example, client computer 210 may comprise a computer 110 as shown in FIG. 1. In the embodiment shown in FIG. 2, client computer 210 is configured to retrieve documents from client storage 220 and transmit the documents to the server 110 over the network for analysis by the server 110. Client storage 220 comprises one or more storage devices comprising documents to be sent for analysis by systems and methods according to one or more embodiments.

In the embodiment shown, the network 230 comprises the Internet, though in some embodiments, the network may include a local area network (LAN), a wide area network (WAN), a virtual private network (VPN) running over a public network, a wireless network, a cellular network, or any other suitable network for allowing communication between the client computer 210 and the server 110.

In the embodiment shown in FIG. 2, the client computer 210 is configured to provide one or more documents from client storage 220 to server 110. For example, a client computer 210 may comprise a computer system located at a company that has engaged an audit service provider to analyze documents. The audit service provider, according to one embodiment, manages server 110 and receives documents from client computer 210 for analysis. The documents are received from the client computer 210 over the network 230 and stored in document storage 250, where they are subsequently accessed for processing and analysis as will be described in greater detail below.

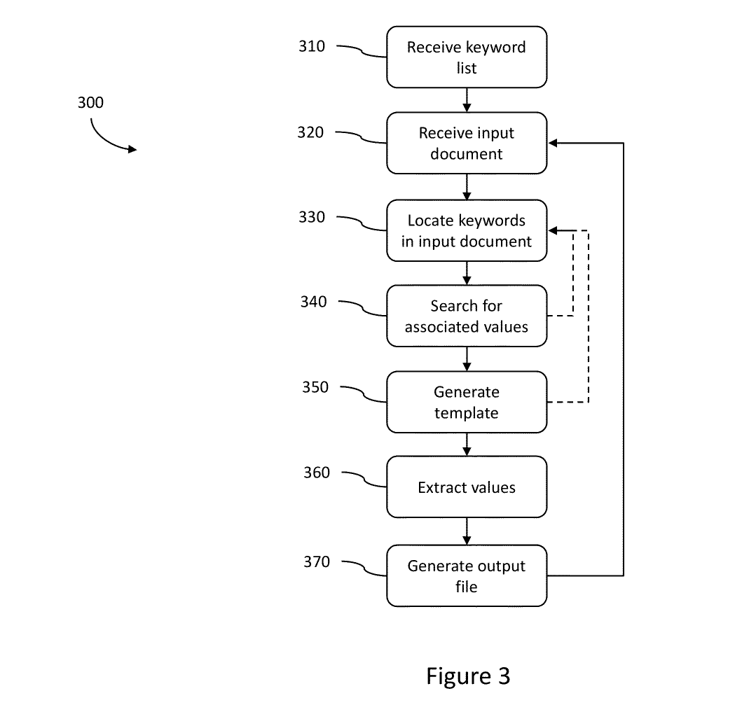

Referring now to FIG. 3, FIG. 3 shows a method for contract assurance according to one embodiment. The method 300 shown in FIG. 3 will be described with respect to the system 200 shown in FIG. 2, but is not restricted to use only on the system 200 of FIG. 2 and may be performed by other suitable systems within the scope of this disclosure.

The method 300 begins in block 310 when the server 110 receives a keyword list from keyword storage 240. In this embodiment, keyword storage 240 comprises a relational database having a plurality of keywords stored in a table. In various embodiments, a keyword may comprise one or more words (e.g. phrases), thus the term keyword should not be read to require that a keyword be a single word. Further, in this embodiment, the keywords are not specific to a particular document or documents, or to a particular client, company, business or analysis. Rather, in this embodiment the keyword list comprises keywords that have been identified and included on the list as they represent terms that may be frequently found within documents having contract information. In some embodiments, however, the keyword list may be customized for a particular document analysis or for a particular client, company, contract, or based on other criteria.

In some embodiments, the server 110 may receive a plurality of keyword lists. For example, in some embodiments, the server 110 may receive a first keyword list comprising a set of standard keywords from keyword storage 240 and may also receive a second set of keywords comprising client-specific keywords, such as from keyword storage 240 or from another source, such as another storage location or from the client computer 210. In one such embodiment, the first and second keyword lists may be merged by the server 110 to provide a single merged keyword list. In some embodiments, the server 110 may maintain each keyword list separately. After receiving the keyword list, the method 300 proceeds to block 320.

In block 320, the server 110 receives an input document. For example, in one embodiment, the server 110 may retrieve a document from document storage 250. In on embodiment, the server 110 may receive a document from the client computer 210. In some embodiments, prior to receiving an input document, the server may filter a set of input documents to remove any documents not including at least one keyword from the received keyword list.

Suitable input documents according to one embodiment include deal files, price change files, contract files, emails (including attachments), portable document format (PDF) files, spreadsheets, purchase history files, invoice files, purchase order files, files in an electronic data interchange (EDI) format, and receiving files indicating product actually received. In some embodiments, documents may comprise physical documents that are received and scanned into an electronic format, such as to a PDF or image file format (e.g. TIFF) with corresponding text created from an optical character recognition of the scanned document. In other types of embodiments unrelated to auditing adherence to contract terms, other types of suitable documents may be employed. For example, embodiments according to this disclosure may be suitable for processing documents related to other fields, such as invoice processing, price change notifications (e.g. from retailers), new item setup processing (e.g. for a retailer receiving information about new products from a supplier), loan document processing, new employee intake and setup, processing benefit forms, financial statements, school applications (e.g. college or university applications), insurance claims processing, expense report processing, banks statements, freight bills, or other fields that employ documents using data stored in tabular form. After the server 110 receives an input document, the method proceeds to block 330.

In block 330, the server 110 locates one or more keywords within the input document. For example, in one embodiment, the server 110 opens the input document and performs searches within the document to identify the location of one or more keywords from the keyword list received in block 310. In some embodiments, the server 110 performs the search of block 330 alternately with block 340 for each keyword. For example, in one embodiment, the server 110 may identify a first keyword from the keyword list and search for the keyword within the input document. In response to locating the keyword within the input document, the method may proceed to block 340 to perform functions described below, and after completing block 340, may return to block 330 to perform an additional search for the keyword or to search for another keyword within the input document.

In the embodiment shown in FIG. 3, the server 110 is configured to search portions of a document that comprises table or table-like portions. For example, with respect to the email 400 of FIG. 4, the server 110 may first identify locations within the document that comprise a table 410 and perform keyword searching within only within the table. In some embodiments, the server 110 may only search for tables within documents of certain types, such as emails or PDFs, while not searching for tables when analyzing input documents that inherently comprise a table-like structure, such as a spreadsheet. In some embodiments, a table like structure may comprise text arranged at common offsets, such as text located a fixed number of tab stops or spaces from a left edge of a document, or may identify a header of a document as comprising a table-like structure having text arranged in apparent rows and columns, such as a vendor name and address, an invoice field and associated invoice number, etc. Note that a table like structure need not have multiple rows. Rather, a table like structure may comprise a keyword, e.g. invoice number, followed by a value, e.g., 14326, such that a spatial relationship between a keyword and an associated value may be determined.

In an embodiment where the server 110 identifies keywords within a table, field, or table-like structure (collectively referred to as tables), the server 110 determines a location of the keyword within the document. For example, in a spreadsheet, the server 110 may determine a location of the keyword using a row and column coordinate, e.g. cell C10. In a text document, the server 110 may determine a location of a keyword based on a line number within the text document and an offset from a left edge of the document. In some embodiments, the server 110 may determine a location of a keyword based on horizontal and vertical offsets within a region of a document, such as line and column numbers. In some embodiments, the server 110 may identify a location of a keyword by identifying the document in which the keyword was located. For example, if a keyword is located in the body of an email, but not within a table, the location of the keyword may be identified by the email itself, such as by a filename, a sender of the email, a date and time the email was received, or other relevant identifying information.

After locating a keyword within the input document, the server 110 stores the location of the keyword and the method may proceeds to block 340 or the server 110 may repeat block 330 to search for the same keyword at another location within the document or performs block 330 with new keyword. If the method returns to block 330 to locate other uses of the same keyword, the method may perform additional processing to eliminate duplicate keyword locations within a document.

For example, in one embodiment, the server 110 may locate a keyword at multiple locations within the input document. The server 110 may then determine one or more uses of the keyword as being unrelated or irrelevant. For example, in one embodiment, the server 110 may locate the term “price” within a footer of a document comprising a file name (e.g. pricesheet.xls) or as a title of a document (e.g. 2010 Price Sheet) such that little or no useful information may be associated with the located keyword. Though, in some embodiments, a term may be properly used multiple times within a document. For example, the term “price” may be repeated at the head of the “price” column on each page of a document, or a separately labeled “price” field may be associated with different products within the same document. Thus, the server 110 may determine whether to store the location of a keyword found within the input document. In response to determining to not store the location of the key, the server 110 may return to block 330 to continue searching. In some embodiments, the server 110 may store a location of an irrelevant keyword usage to ensure it is not subsequently analyzed.

In some embodiments, the server 110 may perform exact matching to locate a keyword. For example, the server 110 may search for “price” within a document and if the exact term “price” is identified, the location of the term is stored; however, if the term “proce” or “pric3” is found within the document, e.g. as a result of a typographical error or an error during an optical character recognition process, there is no exact match. Thus, in some embodiments, fuzzy matching may be employed. For example, in one embodiment, keywords are compared against search terms within a document and a quality of the match is determined, e.g. a score. If the score is sufficiently high, a match is detected and the location of the term in the document is stored. For example, in one embodiment, if a score is greater than or equal to 95%, then a match is identified.

In some cases, multiple keywords or keyword phrases may be found that contain common terms, e.g. “cost” and “new cost.” Embodiments according to this disclosure may handle such apparent duplication in a variety of ways. For example, in one embodiment a document comprises the term “new cost and, both “cost” and “new” are keywords. In this embodiment, because “new cost” matches to two keywords, while “cost” only matches to one, “new cost” is identified while “cost” is not. In some embodiments, three keywords may be identified: “new,” “cost,” and “new cost.” In some embodiments, two keywords may be identified “new” and “cost.” And other keywords may be identified according to various embodiments.

At block 340, the server 110 searches for values associated with keywords located within the input document. To search for values in this embodiment, the server 110 searches in different directions originating at the keyword location. In some embodiments, the server 110 determines a value type associated with the located keyword. For example, the server 110 may determine that the expected value should be a numerical value, e.g. if the located keyword is price, associated values may be expected to be numbers, or text strings having a monetary symbol (e.g. $, [symbol] , £, etc.).

In one embodiment, the server locates the term “price” and searches upwards (or up), downwards (or down), left, right, or in diagonal directions in the document to identify values potentially associated with a located keyword. In a spreadsheet for example, “up” may refer to rows having row numbers less than the row number of the location of the keyword, down may refer to rows having row numbers greater than the row number of the location of the keyword, left may refer to a direction where columns have column numbers less than the column number of the location of the keyword, while right may refer to a direction where columns have column numbers greater than the column number of the location of the keyword.

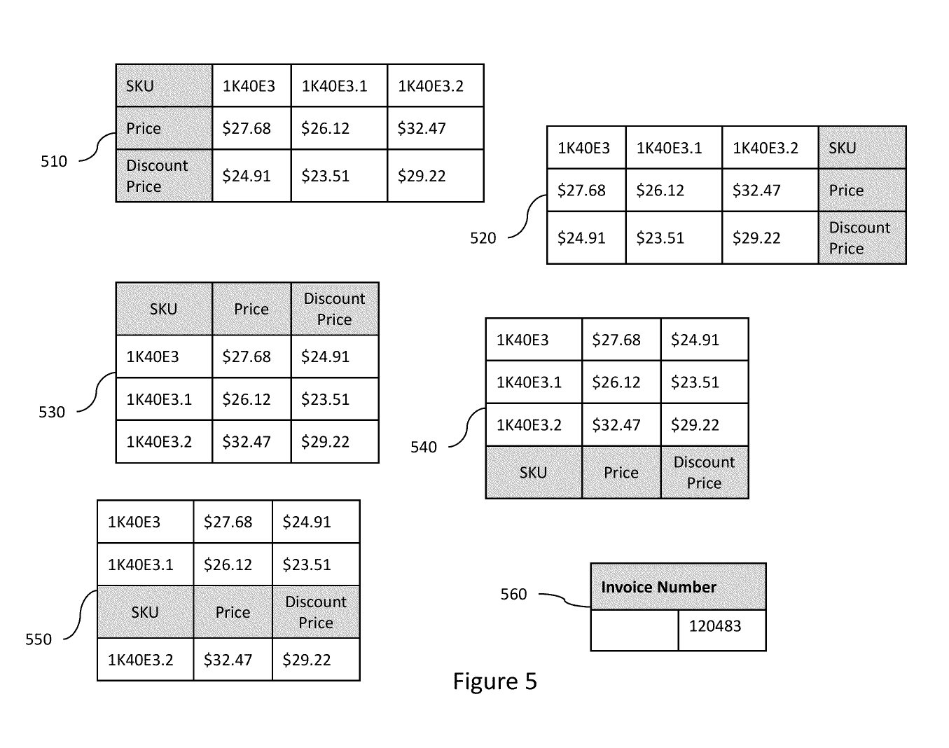

FIG. 5 shows portions of sample input documents that illustrate different search directions. For example, table 510 illustrates an input document in which values associated with keywords are located to the right of keywords. Tables 520, 530, and 540 illustrate input documents in which values associated with keywords are located to the right, downwards, and upwards from the respective keywords. Table 550 illustrates a sample table in which values associated with a keywords are located both upwards and downwards from a keyword (e.g. in a document where a keyword is repeated every 25 rows). Table 560 illustrates a table in which merged cells can result in an associated value being located in a diagonal direction from a keyword. In table 560, the keyword “invoice” is located in cell (1,1), while the invoice number is located in cell (2,2), which is located when the server 110 searches in a diagonal direction down and to the right.

In some embodiments, the server 110 may search all locations within a document that are within a certain radius of a located keyword. In various embodiments, the server 110 may specify a maximum distance from a located keyword to search, such as “no more than 4 rows or columns from the keyword” or “no more than 10 lines or 30 columns from the keyword,” though in some embodiments, the server 110 may search in one or more directions until a value is located or until no more data is available in the selected direction. In some embodiments, the server 110 may search in one or more directions until a non-whitespace value is located that does not correspond to an expected value type for the located keyword. For example, the server 110 may search down from a location of the keyword “price” in a document, but upon encountering a non-numerical value, may terminate the search in that direction and indicate no value was found down from the located keyword. In response to locating a value having an expected value type in a direction, the server 110 stores the direction and distance from the located keyword to the value. In some embodiments, the server 110 may also store the value type of the associated value.

In some embodiments, the server 110 may search for values associated with a keyword in a plurality of directions and terminate the search after finding a first suitable associated value. For example, after finding a number value associated with a price keyword, the server 110 may perform no additional searching for values associated with the price keyword. However, in some embodiments, the server 110 may continue to search for additional values associated with the search term. For example, if the server 110 searches down from a “price” keyword and locates a numerical value, in this embodiment the server 110 stores the direction and distance from the located keyword to the value. The server 110 may then continue to search down from and, upon encountering a subsequent numerical value, the server 110 stores the direction and distance from the located keyword to the next value. In some embodiments, the server 110 may store the location of the associated values, rather than the direction and distance of the associated value from the located keyword. The server 110 may continue to search until no more numerical values are located or locating data that does not have a value type corresponding to an expected value type.

In some embodiments, the server 110 may not search for an associated value. For example, as described above in one embodiment, the server 110 may identify a keyword as being within the body of an email and identify the location of the keyword as the email itself. In one such embodiment, the server 110 does not attempt to identify a value associated with the keyword. Instead, the server 110 may determine that no value are associated with the keyword and skip block 340 for the keyword.

After the server 110 has located one or more values associated with the located keyword, the server 110 may then return to block 330 to locate another keyword or another instance of the same keyword within the input document, or may return to block 340 to begin a search for values associated with another located keyword or another instance of the same keyword, as indicated by the dashed arrow in FIG. 3. After completing the searches for keywords and associated values, the method proceeds to block 350.

In block 350, the server 110 generates a template based on the locations of the keywords in the input document and the locations of the associated values within the input document. For example, the server 110 may generate one or more records for each located keyword comprising the location of the keyword and the location(s) of the value(s) associated with the keyword. In one embodiment, the records are stored in a linked list in non-volatile memory of the server 110. In some embodiments, a file may be generated and stored by the server 110 for potential reuse with another document. For example, in some embodiments, the server 110 may generate an XML file comprising the locations of each keyword in the input document and the locations of each value associated with each keyword in the input document. In some embodiments, the server 110 generates the template concurrently with performing functionality associated with blocks 330 and 340. For example, as each keyword is located, a new entry into a template may be generated and, as associated values are located, information about the associated values may be stored in the template, as indicated by the dashed arrow in FIG. 3. If the server 110 determines that no value are associated with a located keyword (or instance of a located keywords), the server 110 may remove the located keyword (or instance of the located keyword) from the template.

In some embodiments, the server 110 may identify certain values as “static,” which results in the associated label and value. For example, the server 110 may be configured to identify a value as static if only a single value is found to be associated with a keyword. In one embodiment, the server 110 may identify the keyword “vendor” and located an associated vendor name within the document. The server 110 may tag the vendor keyword and associated vendor name as static, which, in this embodiment, causes the vendor name and keyword to be stored in an output file for each document in the collection of documents analyzed by the server 110. Other values may be identified as static, such as based on the identification of particular keywords (e.g. vendor, invoice, purchase order, etc.) or because a search for associated values only returns a single value, potentially indicating the a located keyword has a value of general relevance or applicability.

In some embodiments, as discussed above, the server 110 may skip block 340 in some instances. For example, if a keyword is found within the body of an email, but no corresponding values are identified, they keyword may still be stored within the template along with a flag and identifying information relating to the document in which the keyword was found. For example, the body of an email may mention “new pricing information,” but not include any tabular data. In one embodiment, the server 110 will add a field to the template identifying the keyword “new pricing information” and include an identification of the document in which the keyword was found, such as a file name, or other identifying information, such as a sender and date and time (if the document is an email), a file location, or other identifying information usable to locate the document. Thus, even if the server 110 is unable to identify values associated with keywords, the document may be identified for subsequent manual review for relevant information. After generating the template, the method proceeds to block 360.

In block 360, the server 110 extracts data values from the input document. In one embodiment, the server 110 generates output records for each located keyword within the template and extracts the associated data values from the input document and stores the values in the record. For example, in one embodiment the template indicates a “price” keyword at location (1,4) in a spreadsheet and that associated values are stored in locations (2,4), (3,4), and (4,4) in the spreadsheet. The server 110 creates a record associated with the price keyword at (1,4), and extracts the associated values from the input document and stores the associated values in the record at subsequent positions (e.g. in successive rows or columns within the record). The server 110 then repeats the extraction processing to extract each of the associated data values from the input document. In some embodiments, after all data values have been extracted from a document, the template is discarded.

However, in some embodiments, the template may be retained and potentially reused. For example, in one embodiment, the server 110 may store the template for reuse, such as in memory 114, as well as information describing the type of document the template was generated from. When processing subsequent documents, the server may locate a previously-generated template associated with a document type of a new input document and determine whether template is usable with the new input document. For example, the server 110 may select several candidate located keywords in the template and determine whether the new input document comprises the same keywords in the same locations as were identified in the template. If a sufficient number of matches are found (e.g. more than 90%), the server 110 may reuse the template. In some embodiments, the server 110 may only reuse the template if 100% of the candidate located keywords are found in the new input document.

After extracting the data values, the method proceeds to block 370.

In block 370, the server 110 generates an output document or stores data records in a database. For example, in one embodiment, the server 110 generates a spreadsheet document comprising standardized terms for each located keyword and stores the values associated with each stored keyword in a cell of the spreadsheet. In another embodiment, the server 110 stores each record in a relational database.

In the embodiment shown in FIG. 3, the server 110 generates a single output document for each of the documents that is analyzed. Thus, as each document is searched and data values are extracted, the data is inserted into the output document. In some embodiments, the data from subsequent documents may be appended to the existing documents, though in some embodiments, data may be inserted into existing records, such as in the case where a record has a missing value, or be appended to an existing record.

As was discussed above, in some cases, additional data is added to each record stored in the output file. For example, the server 110 may identify static values during its processing, such as a vendor name. Thus, when generating the output file, the server 110 may include some or all static values with the output data from each analyzed file. Thus, static values may be repeated throughout an output file. In some embodiments, static values may be tagged or otherwise identified as static values. For example, if an output document comprises an XML file, a static value may have a corresponding tag (e.g. <static-value> </static-value>). In a spreadsheet output document, static values may be stored in one or more columns specified for static values. In some embodiments, an output file may comprise a single region in which all static data is stored such that the static data is not repeated, but rather is gathered into a single location for convenient reference.

After the server 110 has stored data in an output file, the server may continue to process documents in the collection of documents and return to block 320. In some embodiments, the server 110 may return to block 310 to receive additional, or different, keywords.

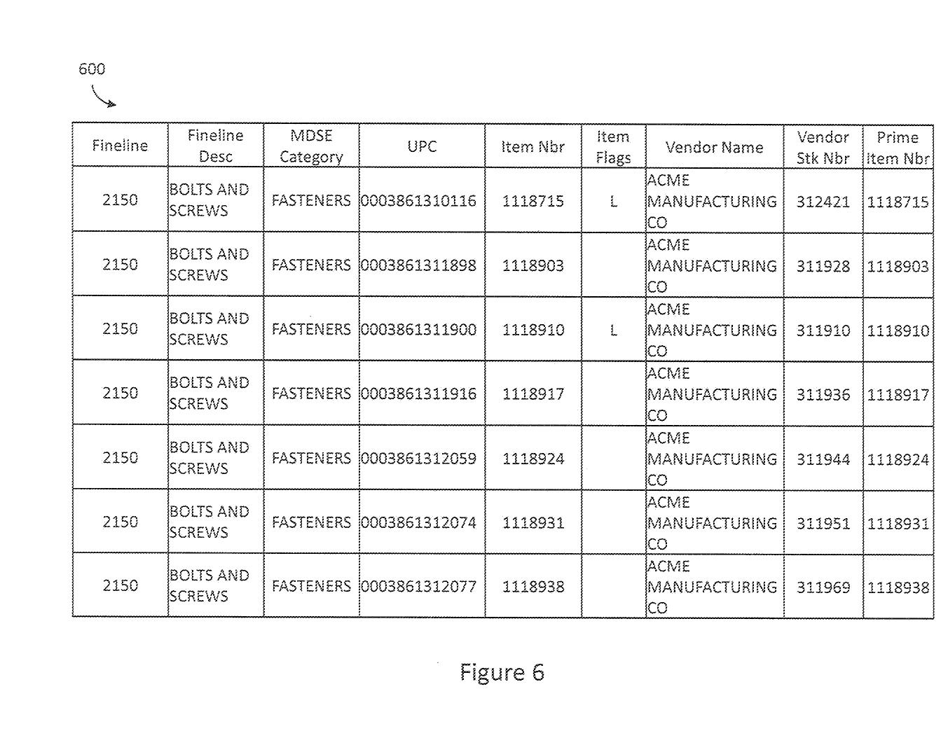

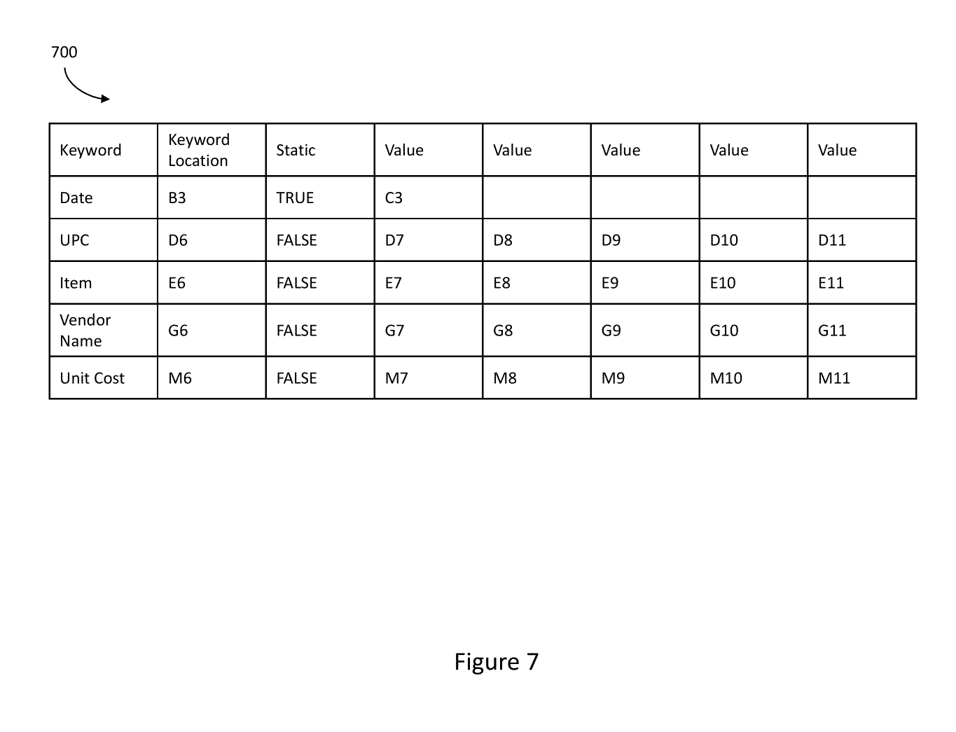

Referring now to FIG. 6, FIG. 6 shows a part of a sample input document 600 according to one embodiment. In the embodiment shown in FIG. 6, the input document comprises a spreadsheet having a number of columns of data as well as some header information. A system according to the present disclosure may identify the “date” information as a static value of “8/13/2008.” The embodiment may then located each of the keywords at the top of the various columns and identify the cells in which associated data is located. For example, in the embodiment shown in FIG. 6, the embodiment may identify “UPC” as a keyword and locate associated values in the rows below the located keyword. A similar analysis may be performed for any other keywords located in the document. The embodiment then generates a template; FIG. 7 shows a partial template 700 that may be generated from the input document 600 in FIG. 6 according to one embodiment.

As may be seen in FIG. 7, the template 700 comprises the locations of keywords and their respective values. In addition, the template indicates whether a keyword and associated value are static.

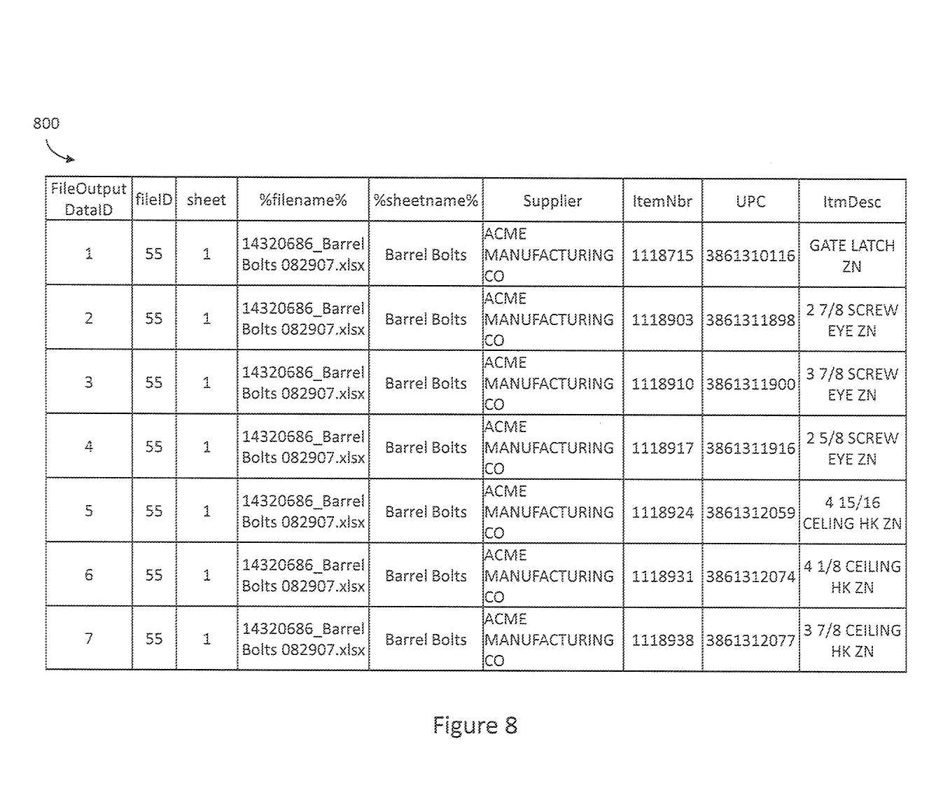

FIG. 8 shows a part of a sample output document 800 generated according to one embodiment. As may be seen in FIG. 8, the sample output document 800 comprises columns having data extracted from the input document and arranged according to standardized labels associated with keywords located within the input document. For example, column K is labeled “Start Date” and includes the static value extracted from the input document associated with the “Effective Date” keyword located in the input document. Similarly, UPC values extracted from the input document are stored in a “UPC” column (column H), unit cost values are stored in column P (labeled “NewUnitCost”), etc. In addition, other information is included as well, such as the name of the file from which the data was extracted (column D) and the worksheet within the file from which the data was extracted (column E).

### General

While the methods and systems herein are described in terms of software executing on various machines, the methods and systems may also be implemented as specifically-configured hardware, such a field-programmable gate array (FPGA) specifically to execute the various methods. For example, referring again to FIG. 5-B, embodiments can be implemented in digital electronic circuitry, or in computer hardware, firmware, software, or in a combination of thereof. In one embodiment, a device may comprise a processor or processors. The processor comprises a computer-readable medium, such as a random access memory (RAM) coupled to the processor. The processor executes computer-executable program instructions stored in memory, such as executing one or more computer programs for editing an image. Such processors may comprise a microprocessor, a digital signal processor (DSP), an application-specific integrated circuit (ASIC), field programmable gate arrays (FPGAs), and state machines. Such processors may further comprise programmable electronic devices such as PLCs, programmable interrupt controllers (PICs), programmable logic devices (PLDs), programmable read-only memories (PROMs), electronically programmable read-only memories (EPROMs or EEPROMs), or other similar devices.

Such processors may comprise, or may be in communication with, media, for example computer-readable media, that may store instructions that, when executed by the processor, can cause the processor to perform the steps described herein as carried out, or assisted, by a processor. Embodiments of computer-readable media may comprise, but are not limited to, an electronic, optical, magnetic, or other storage device capable of providing a processor, such as the processor in a web server, with computer-readable instructions. Other examples of media comprise, but are not limited to, a floppy disk, CD-ROM, magnetic disk, memory chip, ROM, RAM, ASIC, configured processor, all optical media, all magnetic tape or other magnetic media, or any other medium from which a computer processor can read. The processor, and the processing, described may be in one or more structures, and may be dispersed through one or more structures. The processor may comprise code for carrying out one or more of the methods (or parts of methods) described herein.

The foregoing description of some embodiments has been presented only for the purpose of illustration and description and is not intended to be exhaustive or to limit the disclosure to the precise forms disclosed. Numerous modifications and adaptations thereof will be apparent to those skilled in the art without departing from the spirit and scope of the disclosure.

Reference herein to “one embodiment” or “an embodiment” means that a particular feature, structure, operation, or other characteristic described in connection with the embodiment may be included in at least one implementation of the disclosure. The disclosure is not restricted to the particular embodiments described as such. The appearance of the phrase “in one embodiment” or “in an embodiment” in various places in the specification does not necessarily refer to the same embodiment. Any particular feature, structure, operation, or other characteristic described in this specification in relation to “one embodiment” may be combined with other features, structures, operations, or other characteristics described in respect of any other embodiment.

That which is claimed is:

1. A method comprising:
receiving a document, the document comprising a keyword;
determining a location of the keyword within the document;
using the location of the keyword, searching for a value associated with the keyword;
responsive to identifying the value associated with the keyword, storing a location of the value;
generating a template based on the location of the keyword and the location of the value;
extracting the value from the document using the template; and
responsive to extracting the value, storing and associating a label and the extracted value in a second document, the label associated with the keyword.

2. The method of claim 1, wherein searching comprises searching in a plurality of directions for a value associated with the keyword.

3. The method of claim 1, wherein:
identifying the value comprises identified a plurality of values associated with the keyword,
generating the template comprises generating the template based on the location of the plurality of values;
extracting the value comprises extracting the plurality of values; and
storing and associating comprises storing and associating the label and the plurality of extracted values in the second document.

4. The method of claim 1, wherein determining the location of keyword comprises determining the location of each of the plurality of keywords within the document and for each of the plurality of keywords, performing the searching and identifying,
wherein generating the template comprises generating the template based on the location of each of the plurality of keywords and each value associated with each of the plurality of keywords,
wherein extracting the value comprises extracting each of the values from the document, and
wherein storing and associating comprises storing and associating, for each located keyword, a label and each extracted value associated with the respective keyword in the second document.

5. The method of claim 1, wherein the first direction comprises at least one of an up direction, a down direction, a left direction, or a right direction.

6. The method of claim 1, wherein determining the location of the keyword comprises determining that the location of the keyword comprises a plurality of merged cells.

7. The method of claim 6, wherein the first direction comprises at least one of an up direction, a down direction, a left direction, a right direction, or a diagonal direction.

8. The method of claim 1, wherein the document comprises a spreadsheet.

9. A computer-readable medium comprising program code for causing a processor to execute a method, the program code comprising:
program code for receiving a document, the document comprising a keyword;
program code for determining a location of the keyword within the document;
program code for, using the location of the keyword, searching for a value associated with the keyword;
program code for responsive to identifying the value associated with the keyword, storing a location of the value;
program code for generating a template based on the location of the keyword and the location of the value;
program code for extracting the value from the document using the template; and
program code for responsive to extracting the value, storing and associating a label and the extracted value in a second document, the label associated with the keyword.

10. The computer-readable medium of claim 9, wherein the program code for searching comprises program code for searching in a plurality of directions for a value associated with the keyword.

11. The computer-readable medium of claim 9, wherein:
the program code for identifying the value comprises program code for identifying a plurality of values associated with the keyword,
the program code for generating the template comprises program code for generating the template based on the location of the plurality of values;
the program code for extracting the value comprises program code for extracting the plurality of values; and
the program code for storing and associating comprises program code for storing and associating the label and the plurality of extracted values in the second document.

12. The computer-readable medium of claim 9, wherein the program code for determining the location of keyword comprises program code for determining the location of each of the plurality of keywords within the document and for each of the plurality of keywords, performing the searching and identifying,
wherein the program code for generating the template comprises program code for generating the template based on the location of each of the plurality of keywords and each value associated with each of the plurality of keywords,
wherein the program code for extracting the value comprises program code for extracting each of the values from the document, and
wherein the program code for storing and associating comprises program code for storing and associating, for each located keyword, a label and each extracted value associated with the respective keyword in the second document.

13. The computer-readable medium of claim 9, wherein the first direction comprises at least one of an up direction, a down direction, a left direction, or a right direction.

14. The computer-readable medium of claim 9, wherein the program code for determining the location of the keyword comprises program code for determining that the location of the keyword comprises a plurality of merged cells.

15. The computer-readable medium of claim 14, wherein the first direction comprises at least one of an up direction, a down direction, a left direction, a right direction, or a diagonal direction.

16. The computer-readable medium of claim 9, wherein the document comprises a spreadsheet.

17. A system comprising:
a computer-readable medium computer-readable medium comprising program code for causing a processor to execute a method; and
a processor in communication with the computer-readable medium, the processor configured to:
receive a document, the document comprising a keyword;
determine a location of the keyword within the document;
using the location of the keyword, search for a value associated with the keyword;
responsive to identifying the value associated with the keyword, store a location of the value;
generate a template based on the location of the keyword and the location of the value;
extract the value from the document using the template; and
responsive to extracting the value, store and associate a label and the extracted value in a second document, the label associated with the keyword.

18. The system of claim 17, wherein the processor is configured to search in a plurality of directions for a value associated with the keyword.

19. The system of claim 17, wherein the processor is further configured to:
identify a plurality of values associated with the keyword,
generate the template based on the location of the plurality of values;
extract the plurality of values; and
store and associate the label and the plurality of extracted values in the second document.

20. The system of claim 17, wherein the processor is further configured to:
determine the location of each of the plurality of keywords within the document and for each of the plurality of keywords, performing the searching and identifying,
generate the template based on the location of each of the plurality of keywords and each value associated with each of the plurality of keywords,
extract each of the values from the document, and
store and associate, for each located keyword, a label and each extracted value associated with the respective keyword in the second document.
